(19) United States
(12) Patent Application Publication
(10) Pub. No.: US 2009/0098352 A1
(43) Pub. Date: Apr. 16, 2009

(54) Waterproof, Water Vapour-Permeable Multilayer Membrane

(75) Inventors: Gabriele Beate Wittmann, Munchen (DE); Henricus Joannes Maria Van De Ven, Arnhem (NL); Andrea Annelene Kiel, Wuppertal (DE)

Correspondence Address: OLIFF & BERRIDGE, PLC, P.O. BOX 320850, ALEXANDRIA, VA, 22320-4850, US

(73) Assignee: SYMPATEX TECHNOLOGIES GMBH, WUPPERTAL (DE)

(21) Appl. No.: 12/086,417

(22) PCT Filed: Dec. 21, 2006
(86) PCT No.: PCT/EP2006/012385

§ 371 Date: Jun. 12, 2008

(30) Foreign Application Priority Data
Dec. 24, 2005 (EP) 05028462.9

(51) Int. Cl. B32B 7/02; B32B 27/40; B32B 27/36; B32B 3/26

(52) U.S. Cl. 428/213; 428/316.6; 428/220; 428/212; 442/287; 442/291; 442/304; 442/395; 442/394; 442/50

(57) ABSTRACT

Waterproof, water vapour-permeable multilayer membrane having at least one first and one second layer, with all the layers being made of a thermoplastic polymer from the group of polyether esters, the group of polyether amides or the group of polyether urethanes and being joined together, characterised in that contiguously arranged layers are made of thermoplastic polymers from different groups.

The invention relates to a waterproof, water vapour-permeable multilayer membrane having at least one first and one second layer, with all the layers being made of a thermoplastic polymer from the group of polyether esters, the group of polyether amides or the group of polyether urethanes and being joined together.

Such membranes are known, for example, from EP 1 264 684 A1. In these membranes the first layer is produced by coating a carrier with a solution containing the thermoplastic polymer. The second layer of the membrane is subsequently produced by coating the first layer. In this publication it is stated that the necessary water vapour permeability for the multilayer membrane is achieved in that a compatible hydrophilic plasticiser is added to the polymer for the second layer before it is employed for coating the first layer. Furthermore according to EP 1 264 684 A1, either the same or similar polymer should be employed for adjacent layers. This is due to the fact that if different groups of the above-mentioned polymer groups were to be employed in adjacent layers, adjacent layers would adhere only slightly to one another with the result that such multilayer membranes would delaminate, in other words separate into individual layers, under the slightest loads and would no longer be multilayer membranes or at least could no longer be used as such.

The object of the present invention is to provide a further waterproof, water vapour-permeable multilayer membrane.

This object is achieved with a waterproof, water vapour-permeable multilayer membrane having at least one first and one second layer, with all the layers being made of a thermoplastic polymer from the group of polyether esters, the group of polyether amides or the group of polyether urethanes and being joined together in that contiguously arranged layers are made of thermoplastic polymers from different groups.

It was in fact discovered that through a selective choice of polymers it is possible with multilayer membranes to achieve an acceptable adhesion and hence joining of adjacent layers, despite different polymer groups, and hence to significantly reduce the risk of delamination. Coupling agents are normally required to join adjacent polymer layers. The choice of polymers according to the invention allows the use of such coupling agents to be waived. The addition of a plasticiser is also not necessary here. The membrane of the invention is thus characterised in particular in that all the layers contain no plasticiser and no coupling agent. A further advantage of the membrane of the invention is to be seen in that within the group of the selected polymers, those polymers can be selected that ensure the water vapour permeability necessary for the particular application.

Although the multilayer membrane of the invention can be produced by means of all known processes, such as listed for example in EP 1 264 684 A1 ([0082]), it has proved to be particularly favourable if the multilayer membrane is produced in such a way that all the intended layers of the membrane are extruded together from the melt at the extrusion die provided for the delivery of the polymers. The desired water vapour permeability can be quite easily achieved by a corresponding choice of the polymers within the given group and also by a corresponding setting of the thicknesses of the individual layers. Suitable equipment for this type of production of multilayer membranes is well known to persons skilled in the art.

For example, an extrusion die from Egan Davis that has become known under the designation “Pro Pak Conical Die” can be employed as the extrusion die. With this die, the melt for the first layer is applied to the wall of the die and transported under pressure upwards, then a further melt for the second layer is applied to the flowing melt, and possibly further melts are applied to this second layer before the melts are extruded together from the annular slit at the end of the wall. The layer thicknesses of the individual layers of the multi-layer membrane can be influenced by a corresponding setting of the flow volumes of the individual melts and of the drawing in longitudinal and transverse direction after leaving the die. It can also be expedient to extrude at the same time a carrier layer as innermost and/or outermost layer, for example of polyethylene, and to peel it off again after completion of the membrane in order to avoid damaging the membrane.

The membrane of the invention preferably contains no plasticiser, and therefore comprises only the additives normally used in membranes such as inorganic particles, pigments, thermal and/or oxidative stabilisers, UV stabilisers, polyolefins, etc., and/or anti-blocking agents in order to prevent sticking when the membrane is coiled. As a rule, the membrane should not contain more than 15 wt. % of these additives relative to the total weight.

The membrane of the invention is characterised in particular in that it has a water vapour permeability (WVTR), measured according to ASTM E 96-95, Procedure BW, water temperature 30° C., of 3,000 to 65,000 g/m²/24 h.

In particular the membrane of the invention has a water vapour permeability (WVTR), measured according to ASTM E 96-95, Procedure B, water temperature 30° C., of 200 to 5,000 g/m²/24 h.

The membranes of the invention are characterised furthermore by a total thickness of 2 to 100 μm, preferably of 5 to 50 μm, whereby the individual layers have the same thickness, but preferably different thicknesses. The advantages of the different groups of polymers can therefore be exploited according to the invention.

For example, the thicker layer can be selected from the group of polyether esters and the thinner layer from the group of polyether amides, thereby exploiting the fact that polyether amides are generally more resistant to UV radiation than polyether esters; for this reason, the layer made from a polyether amide represents a protective layer for the layer made from a polyether ester in the given combination, whereby it can be observed that a low thickness is already sufficient for this purpose. Such a protective layer can also be employed with respect to the resistance to certain chemicals to which the polyether amide layer is resistant.

If one of the outer layers is formed from the group of polyether urethanes, this layer enhances the weldability of the membrane.

The membrane of the invention preferably consists of two layers. Furthermore, membranes whose layers exhibit different water vapour permeabilities have proved to be highly effective.

The membrane of the invention is particularly suitable for the production of breathable clothing. Clothing in the context of the present invention is understood as all fabrics worn on the body. This includes in particular also gloves, caps, hats and shoes. The membrane of the invention is particularly suitable for this when even after 5 washes, preferably after 10 washes at 40° C. in accordance with DIN EN ISO 6330:2000 or after 7 dry cleaning cycles, preferably after 12 dry cleaning cycles in accordance with DIN EN ISO 3175-1:1998 the layers are at least predominantly still bonded to one another. Particularly with washing it can be observed in most cases that a delamination takes place only after 30 washes or more. Adjacent layers are still predominantly bonded to one another when 90% of the total surface area of the membrane still exhibits bonded layers and only 10% of the total surface area of the membrane exhibits delaminated areas. The delaminated areas are recognisable from the fact that a delamination presents itself as a clouding of the membrane.

For the production of clothing, the membranes of the invention are bonded depending on the application on one or both sides with textile fabrics, generally by means of adhesives applied in spots or lines, whereby laminates are formed. Suitable textile fabrics for this are woven or knitted fabrics, layed fabrics, non-wovens, nets, but also 2-dimensional warp knits and similar textile fabrics.

In a preferred embodiment the membrane of the invention is bonded on one of its outer layers to a textile fabric, whereby the textile fabric is bonded directly to the membrane of the invention without the additional use of adhesives, i.e. the bond between the membrane of the invention and the textile fabric is effected solely by the membrane and/or the fibres of the textile fabric.

This can be effected, for example, by thermocalandering. The outer layer of the membrane is thereby slightly melted so that the textile fabric partially penetrates the outer layer of the membrane and thus forms a bond with the membrane of the invention.

In a particularly preferred embodiment the textile fabric consists of thermoplastic polymers with one part polymers with a low melting point and one part polymers with a higher melting point. The part with the low melting point is slightly melted by exposure to heat in the same way as the outer layer of the membrane of the invention so that a stable bond can be created between the membrane and the part of the textile fabric with low melting point by physical or chemical means. This type of bond results in outstanding adhesion between membrane and textile fabric and thus creates a very high resistance to delamination. The membrane of the invention in combination with a textile fabric is particularly suitable for the production of clothing, as the application of the textile fabric prevents direct contact between membrane and skin and thus improves the feeling of the clothing containing the membrane of the invention on the skin. An additional inner lining is therefore not necessary.

A textile fabric consisting of thermoplastic polymers with one part polymers with a low melting point and one part polymers with a higher melting point can be obtained, for example, by the use of fibres essentially consisting of a copolymer with one part polymers with a low melting point and one part polymers with a higher melting point. This copolymer can be a block polymer or a graft polymer. Such textile fabrics in the form of a woven or knitted fabric, layed fabric, non-woven, net, web or mesh are known to persons skilled in the art. They are supplied, for example, by Hänsel Verbundtechnik or Protechnic and are normally employed as a bonding layer between two textile fabrics. The textile fabrics for combination with the membrane of the invention are preferably made of copolyester, copolyamide or copolyurethane.

A further possibility is the use of textile fabrics in the form of a woven or knitted fabric, layed fabric, non-woven, net, web or mesh that consist essentially of bicomponent fibres comprising a polymer with a low melting point and a polymer with a higher melting point, whereby here core/sheath bicomponent fibres with a sheath with low melting point and a core with higher melting point have proved to be particularly suitable.

Suitable textile fabrics for combination with the membrane of the invention can naturally contain one part fibres consisting of a polymer with a low melting point and one part fibres consisting of a polymer with a high melting point.

It has also been discovered that the membrane of the invention, processed to form a laminate, is particularly suitable for the production of sleeping bags, tents or tarpaulins.

Thermoplastic polymers essentially comprising the following components are particularly suitable for the waterproof, water vapour-permeable multilayer membrane according to the present invention:
Polyether ester:
   Polybutylene terephthalate—70 wt. %
   Polyethylene glycol (4000)—30 wt. %
Polyether ester:
   Polybutylene terephthalate—50 wt. %
   Polyethylene glycol (2000)—25 wt. %
   Polytetrahydrofuran—25 wt. %
Polyether amide:
   Polyamide 6-60 wt. %
   Polyethylene glycol (2000)—20 wt. %
      Polypropylene glycol (2000)—20 wt. %
Polyether urethane:
   Methyl diisocyanate—42 wt. %
   Butanediol—8 wt. %
   Polyethylene glycol—50 wt. %

The invention is explained in further detail by reference to the following examples.

An extrusion die from Egan Davis that has become known under the designation “Pro Pak Conical Die” was used as extrusion die for the production of the membranes described below. For production of the membrane, a first polymer was melted and applied as the first layer to the wall of the die, then transported upwards under pressure. Then a second melt melted from a second polymer for the second layer was applied to the flowing melt of the first polymer forming the first layer. The two melts were then extruded together through the annular slit with a diameter of roughly 60 cm at the end of the wall. The two-layer membrane created by the cooling of the melt is inflated using air until the membrane has a circumference of roughly 4 m. This membrane was then laid flat and coiled.

The properties of the membranes were measured as follows:

The water vapour permeability was measured in accordance with ASTM E 96-1995 using both “Procedure BW—Inverted Cup Method” and “Procedure B—Upright Cup Method”, with the water temperature set to 30° C. in both cases. Both test methods were performed with the membrane layer consisting of the one polymer as well as with the membrane layer consisting of the other polymer facing towards the water side.

Washing of the membrane was performed in each case in accordance with DIN EN ISO 6330:2000 at a water temperature of 40° C. Dry cleaning of the membrane was performed in accordance with DIN EN ISO 3175-1:1998.

### EXAMPLE 1

A polyether ester was employed as the first polymer and a polyether amide as the second polymer. The extruded volumes of melt were 40 kg/h polyether ester and 54.5 kg/h polyether amide. The resulting membrane had a total thickness of 17 μm, whereby the layer of polyether ester had a thickness of 7 μm and the layer of polyether amide a thickness of 10 μm.

The polymers essentially comprised the following components:

| Polyether ester: | Polyether amide: |
|---|---|
| Polybutylene terephthalate - | Polyamide 6 - 60 wt. % |
| 70 wt. % | Polyethylene glycol (2000) - |
| Polyethylene glycol (4000) - | 20 wt. % |
| 30 wt. % | Polypropylene glycol (2000) - |
| | 20 wt. % |

The water vapour permeability of the two-layer membrane produced exhibited the following values:

| | Polyether ester | Polyether amide |
|---|---|---|
| | to the water side | to the water side |
| Procedure BW (g/m²/24 h) | 23,800 | 27,500 |
| Procedure B (g/m²/24 h) | 2,800 | 3,000 |

The membrane exhibited first signs of delamination in the form of cloudiness over less than 12% of the total surface area after 38 washes and after 45 dry cleaning cycles respectively.

### EXAMPLE 2

Before the first polymer was applied to the wall of the die, a melt of polyethylene was first placed onto the wall as a carrier layer. Polyether urethane was applied as first polymer and polyether ester as second polymer to this carrier layer. The extruded volumes of melt were 47.4 kg/h polyether urethane and 37.1 kg/h polyether ester. After the polyethylene carrier layer had been peeled off, the resulting membrane had a total thickness of 15.5 μm, whereby the layer of polyether urethane had a thickness of 9 μm and the layer of polyether ester a thickness of 6.5 μm.

The polymers essentially comprised the following components:

| Polyether urethane: | Polyether ester: |
|---|---|
| Methyl diisocyanate - 42 wt. % | Polybutylene terephthalate - 50 wt. % |
| Butanediol - 8 wt. % | Polyethylene glycol (2000) - 25 wt. % |
| Polyethylene glycol - 50 wt. % | Polytetrahydrofuran - 25 wt. % |

The water vapour permeability of the two-layer membrane produced exhibited the following values:

| | Polyether urethane | Polyether ester |
|---|---|---|
| | to the water side | to the water side |
| Procedure BW (g/m²/24 h) | 27,400 | 19,700 |
| Procedure B (g/m²/24 h) | 2,970 | 2,850 |

The membrane exhibited first signs of delamination in the form of cloudiness over less than 8% of the total surface area after 42 washes and after 51 dry cleaning cycles respectively.

### EXAMPLE 3

Polyether amide was employed as the first polymer and polyether urethane as the second polymer. The extruded volumes of melt were 76.3 kg/h polyether amide and 36.9 kg/h polyether urethane. The resulting membrane had a total thickness of 21 μm, whereby the layer of polyether amide had a thickness of 14 μm and the layer of polyether urethane a thickness of 7 μm.

The polymers essentially comprised the following components:

| Polyether amide: | Polyether urethane: |
|---|---|
| Polyamide 6-60 wt. % | Methyl diisocyanate - 42 wt. % |
| Polyethylene glycol (2000) - 20 wt. % | Butanediol - 8 wt. % |
| Polypropylene glycol (2000) - 20 wt. % | Polyethylene glycol - 50 wt. % |

The water vapour permeability of the two-layer membrane produced exhibited the following values:

| | Polyether amide | Polyether urethane |
|---|---|---|
| | to the water side | to the water side |
| Procedure BW (g/m²/24 h) | 25,400 | 30,700 |
| Procedure B (g/m²/24 h) | 3,030 | 3,180 |

The membrane exhibited first signs of delamination in the form of cloudiness over less than 9% of the total surface area after 45 washes and after 53 dry cleaning cycles respectively.

1. Waterproof, water vapour-permeable multilayer membrane having at least one first and one second layer, with all the layers being made of a thermoplastic polymer from the group of polyether esters, the group of polyether amides or the group of polyether urethanes and being joined together, wherein contiguously arranged layers are made of thermoplastic polymers from different groups.

2. Membrane according to claim 1, wherein it has a water vapour permeability (WVTR), measured according to ASTM E 96-95, Procedure BW, water temperature 30° C., of 3,000 to 65,000 g/m²/24 h.

3. Membrane according to claim 1, wherein it has a water vapour permeability (WVTR), measured according to ASTM E 96-95, Procedure B, water temperature 30° C., of 200 to 5,000 g/m²/24 h.

4. Membrane according to claim 1, wherein it has a total thickness of 2 to 100 μm.

5. Membrane according to claim 4, wherein it has a total thickness of 5 to 50 μm.

6. Membrane according to claim 1, wherein the layers have different thicknesses.

7. Membrane according to claim 1, wherein it consists of two layers.

8. Membrane according to claim 1, wherein the layers have different water vapour permeabilities.

9. Membrane according to claim 1, wherein the layers of the membrane are at least predominantly still bonded to one another even after 5 washes in accordance with DIN EN ISO 6330:2000, but at 40° C.

10. Membrane according to claim 9, wherein the layers of the membrane are at least predominantly still bonded to one another even after 10 washes in accordance with DIN EN ISO 6330:2000, but at 40° C.

11. Membrane according to claim 1, wherein the layers of the membrane are at least predominantly still bonded to one another even after 7 dry cleaning cycles in accordance with DIN EN ISO 3175-1:1998.

12. Membrane according to claim 11, wherein the layers of the membrane are at least predominantly still bonded to one another even after 12 dry cleaning cycles in accordance with DIN EN ISO 3175-1:1998.

13. Membrane according to claim 1, wherein the membrane is joined to a textile fabric at one of its outer layers.

14. Membrane according to claim 13, wherein the bond between the membrane of the invention and the textile fabric is effected solely by the membrane and/or the fibres of the textile fabric.

15. Membrane according to claim 13, wherein the textile fabric is a woven fabric, knitted fabric, layed fabric, non-woven, net, web or mesh.

16. Membrane according to claim 13, wherein the textile fabric comprises one part polymers with a low melting point and one part polymers with a higher melting point.

17. A method for the production of laminates, comprising: utilizing the membrane according to claim 1.

18. A method for the production of clothing comprising utilizing membranes according to claim 1 or laminates produced from these membranes.

19. A method for the production of sleeping bags, tents or tarpaulins, comprising utilizing membranes according to claim 1 or of laminates produced from these membranes.
